(19) United States
(12) Patent Application Publication
(10) Pub. No.: US 2013/0196091 A1
(43) Pub. Date: Aug. 1, 2013

(54) FIRE-RESISTANT GLAZING

(71) Applicants: Klaus Wildenhain, Grevenbroich (DE); Udo Gelderie, Wurselen (DE); Norbert Schwankhaus, Baesweiler (DE)

(72) Inventors: Klaus Wildenhain, Grevenbroich (DE); Udo Gelderie, Wurselen (DE); Norbert Schwankhaus, Baesweiler (DE)

(73) Assignee: VETROTECH SAINT-GOBAIN (INTERNATIONAL) AG, Flamatt (CH)

(21) Appl. No.: 13/704,018

(22) PCT Filed: Jun. 28, 2011
(86) PCT No.: PCT/CH2011/000154

§ 371 Date: Mar. 21, 2013

(30) Foreign Application Priority Data
Jun. 29, 2010 (CH) 1048/10

(51) Int. Cl. B32B 17/06; E06B 5/16

(52) U.S. Cl. CPC B32B 17/06; E06B 5/165
USPC 428/34; 428/43

(57) ABSTRACT

A fire-resistant glass unit is provided having at least two transparent carrier elements, in particular glass panes, and an intermediate layer between the carrier elements, this layer expanding for example in the event of a fire, or a gas-releasing intermediate layer, which builds up a pressure between the carrier elements. At least one glass pane of the fire-resistant glass unit, preferably the two outermost glass panes, or even all the glass panes adjacent to an intermediate layer, are provided with specific local weakening as a defined breaking point. A predetermined breaking point may be, for example, a groove or milled recess, in particular a notch.

### BACKGROUND OF THE INVENTION

1. Field of the Invention

The invention relates to a fire protection glass, in particular a fire protection glazing, having at least two transparent support elements of which at least one is a glass pane (glass plate) and having an intermediate layer, for example an intumescent fire protection layer, in the intermediate space between the support elements.

2. Description of Related Art

Such fire protection glazing is known, for example, from EP 0 620 781. The fire protection layer taught in this document is an aqueous alkali metal silicate which is produced by curing of a water-containing filling composition composed of an alkali metal silicate and a hardener to form a polysilicate. The molar ratio of silicon dioxide to alkali metal oxide in the polysilicate is at least 4:1.

Further fire protection glazing having an intermediate fire protection layer is taught, for example, by FR 2 607 491 or WO 2007/118887. In contrast to EP 0 620 781, in this laminated glass, the alkali metal silicate is dried on a glass pane. The second glass pane is adhesively bonded to the fire protection layer after the drying process.

Other kinds of fire protection glazing have intermediate fire protection layers composed of hydrogels and/or, for example configured as insulating fire protection glasses, intermediate layers composed of silicones, epoxy resins, polyvinyl butyral (PVB), ethylene-vinyl acetate (EVA), thermoplastic elastomers based on polyurethane (TPU) or fluorinated hydrocarbons (THV), etc.

For many embodiments, the glass panes used as support elements are configured as single-pane safety glass (SPSG), i.e. thermally and/or chemically toughened glass. These have firstly the known safety advantages that in the case of breakage they disintegrate into many small fragments which incur a reduced risk of injury. Secondly, as a result of their increased thermal shock resistance, they also contribute to the advantageous fire-resistance properties of the laminated glass.

Such kinds of fire protection glazing have performed very well in practice and they have the necessary stability in the case of fire, depending on the specification, and meet the requirements prescribed by the relevant standards.

### BRIEF SUMMARY OF THE INVENTION

It is an object of the invention to increase the safety of fire protection glazing even further.

This object is achieved by the invention as defined in the claims.

The invention is essentially characterized in that at least one glass pane (glass plate) of the fire protection glazing unit, preferably the two outermost glass panes (i.e. the two glass panes in the case of a glazing having precisely two glass panes) or all glass panes adjoining an intermediate layer are provided with a deliberate local weakening (predetermined breaking point; defined weak point). A predetermined breaking point can, for example be a furrow, in particular a notch.

The terms “glass plate” or “glass pane” in the present case refer not only to flat elements but also includes glass plates which comprise inward or outward arching or curvature.

For the present purposes, the fire protection glazing is an assembly which has fire protection properties and comprises at least two transparent support elements (glass panes or panes composed of a polymer glazing material) between which an intermediate layer is arranged. The transparency can also be only partial transparency, for example as a result of at least one of the support elements being colored and/or (partially) opacified. The intermediate layer can be homogeneous or comprise a plurality of sublayers. In addition to the at least two glass panes joined by an intermediate layer, further elements can be present, for example a further transparent glass or polymer pane and a gas-filled or evacuated intermediate space, as a result of which the combined glass becomes an insulating fire protection glass.

Predetermined breaking points on individual glass panes, also by means of notches, have been known for a long time, for example from CH 548 525. However, introduction of a deliberate local weakening in a fire protection glass would appear detrimental to the purpose of a fire protection glass since a fire protection glass should remain intact for as long as possible, in particular even under great thermal stresses. It has surprisingly been found that in the case of fire protection glazing, a strengthening of the entire composite is achieved by at least one glass pane, preferably at least two glass panes separated by an intermediate layer and/or at least two outermost glass panes being provided with a deliberate local weakening. In particular, it has been found that such a deliberate local weakening can prevent the following case: when a high degree of heat acts on the glass, a tremendous pressure can build up between the panes. If the fire-side pane then breaks under full load, a relatively large amount of energy is released in an explosive fashion and, for example, door mechanisms become detached, leading to opening of doors, or clipped-on glass holding strips are loosened and then fall into the region of the fire. This leads to premature failure of the component.

Such bursting of the panes can in the case of fire protection glazing according to the prior art be attributed to, for example, an overpressure caused by vaporization of materials between the glass panes (for example water in the case of an intumescent fire protection layer or due to hydrogels which release water and display a cooling action) as a result of which a relatively large amount of energy is released in an explosive fashion on bursting of the fire-side glass pane. This released energy of the fire-side SPSG pane which bursts relatively late releases mechanical forces in the component which can make glass holding strips come off or open doors in the component.

In contrast thereto, the procedure according to the invention results in relatively little energy being released in the breaking of the fire-side glass pane, which generally takes place first, and, in particular, the glass pane which is in each case further removed from the seat of the fire is, thus, not endangered. The approach according to the invention brings about early bursting of the fire-side glass without too much pressure energy being able to built up.

In the breaking of the fire-side glass pane, the deliberate local weakening acts as predetermined breaking point (defined fracture point) and the temperature gradient ΔT on breaking is reduced. Later bursting with liberation of a large quantity of energy and associated shock waves is, thus, prevented by this controlled fracture of the glass. After fracture of the fire-side glass pane, the fire protection effect of the intermediate layer and the remaining glass pane(s) remains intact and no increased pressure can be built up in the intermediate space between the glass panes.

Since in many cases the side of a component provided with fire protection glazing on which a fire would break out is often not known and because the side of the fire protection glass which is installed facing the fire is often also not known, it is advantageous to provide both glass panes adjoining an intermediate layer with a weakening/predetermined breaking point.

The intermediate layer can be an intumescent/expanding fire protection layer with or without an edge compound, for example a layer based on alkali metal silicate, for example as described in EP 0 620 781, or a layer produced by drying of an alkali metal silicate composition. However, it can also be a hydrogel fire protection layer or an intermediate layer composed of silicone, epoxy resin, polyvinylbutyral (PVB), ethylene-vinyl acetate (EVA), thermoplastic elastomers based on polyurethane (TPU), fluorinated hydrocarbons (THV), etc. In general, the intermediate layer will be solid and/or liquid, with systems composed of solid and liquid phases (e.g. disperse systems, including gels) and systems having a solid-liquid transition which is not clearly defined also being possible.

The intermediate layer can, in particular, be configured so that gas is formed or the molar amount of gas is increased in the intermediate space between the support elements as a result of the action of heat under fire protection test conditions (for example in the case of temperatures acting on the glazing in the case of heat stress as a function of time in accordance with ISO 834-1) due to a physical phase transformation (vaporization of water or another solvent, for example in small bubbles in the case of intumescent materials, liquefaction of a solid) and/or a chemical reaction, for example a thermal decomposition (pyrolysis). The pressure p obeys, as an approximation, the general gas equation V·p=n·R·T where n=m/MM is the molar amount of gas. (m is the mass of a substance in the gas phase, MM is the molar mass of the respective gas). Furthermore, V is the volume, R is the universal gas constant and T is the absolute temperature in the equation. However, the mass m of the substance in the gas phase increases continuously during the fire as a result of the phase transformation and/or reaction. The pressure in the pane therefore increases to a greater extent than when the intermediate space between the glass panes were to be merely filled with a gas and the mass m of the gas, for example in the case of insulating glass, were always to be constant.

This can bring about an increase in pressure above the increase in pressure which a purely gas-filled intermediate layer volume would experience according to the laws applying to “ideal gas” (Amontons' law). The increase in pressure of the existing or generated gases in the case of rising temperature then generally occurs according to the laws known from physical chemistry for ideal or real gases (“gas laws”).

In most embodiments, the glass panes are flat glass plates.

In many embodiments, the glass panes used as support elements are configured as safety glasses, i.e. toughened glasses. Toughened glasses can be thermally toughened glasses (for example in accordance with DIN 12150-1 or DIN EN 14179-1 (heat-treated single-pane safety glass)) or chemically toughened glasses (EN 12337). In particular embodiments, partially toughened glasses, e.g. in accordance with DIN EN 1863, can also be used. In particular, in embodiments in which both or all glass panes joining an intermediate layer are provided with a defined weakening, both/all these glass plates provided with a weakening are toughened or possibly at least partially toughened.

A local weakening can, for example, be present as a positionally defined and delimited removal of material carried out on the glass plate (pane) (in general, optionally, before prestressing). It can be in the form of a furrow/notch, for example a milled groove, depression, drilled hole or other suitable shape. The deliberate local weakening can be brought about by mechanical means (e.g. by means of suitable glass machining machines, glass milling machines, glass drills, glass scoring tools, etc.) or by other means, for example lasers, water jet glass machining machines, etc.

When the glass pane is in the form of flat glass having a rectangular, rhomboid, circular, elliptical, etc., shape, this can deviate from its otherwise convex shape in the mathematical sense as a geometric body as a result of the local weakening. A geometric body is convex in the mathematical sense when every connecting line between two points on the body is within the body; the property “convex” does not imply curvature of the, in many embodiments flat, glass panes. These local weakenings differ, for example as a result of this deviation from the convex shape, from other removals of material which may possibly be carried out, for example ground chamfers, mitered edges, etc. In particular embodiments, especially in embodiments in which the fire protection glass is not configured as flat glass or, for example, in a star shape, the base shape is not necessarily convex. However, subregions of the fire protection glass can be convex in the above sense and the deliberate local weakening can locally represent a deviation from this shape.

The deviation from the convex shape creates, as desired, a deliberate weak point which serves as a predetermined breaking point. Such a weakening in the form of a groove/notch, depression, drilled hole, etc., in the case of flat glass generally as a deviation from the mathematically convex shape, will here also be referred to as “mechanical weakening”.

The predetermined breaking point can, for example, be configured so that fracture occurs at temperature gradients ΔT in the range from 40 K to 250° K. ΔT is defined as the thermal gradient between a point in the glass pane having a high temperature (generally in the case of fire the surface or middle of the pane) and a point having a lower temperature (generally the peripheral region of the pane in the rebate of the frame system due to covering of the edge of the glass). The thermal gradient at which the glass breaks spontaneously (float glass or single-pane safety glass basis) is, according to the literature, at about 40 K for industrially annealed glasses (float glass) and 150 K for thermally toughened glasses (single-pane safety glass).

The predetermined breaking point can also be defined in terms of the glass pane withstanding the standardized pendulum impact test (DIN EN 12600) despite the predetermined breaking point and the same mechanical safety properties as in the case of single-pane safety glass which has not been deliberately damaged being present.

Instead of a mechanical local weakening or in addition thereto, a deliberate local chemical weakening of the glass can also be provided. Such a local chemical weakening comprises, for example, local provision of another, mechanically less stable material of the glass pane, for example by replacement of ions (for example replacement of sodium by potassium) in the vicinity of the glass surface along the deliberate local weakening. Replacement of ions at the glass surface which is not merely local is known per se from chemical prestressing processes. A local chemical weakening can be optically invisible and can therefore also be present in places where mechanical weakening would be visually disadvantageous. In particular, the chemical weakening can be, for example, in the form of a line and extend over an entire width of the glass pane.

Furthermore, weakening in the above-described way can also be achieved by laser treatment of the glass, in which removal of material does not necessarily have to occur.

The deliberate (mechanical) local weakening or the deliberate local weakenings can, for example, be present as a furrow (having a constant or varying depth, width and/or direction). An example of a furrow, which does not have a constant depth but instead has a depth which decreases steadily away from the edge, is a notch. In addition, or as an alternative thereto, blind holes in the edge or a flat side, pairs of blind holes which are aligned with one another in the two flat sides, through-holes, or others are considered.

The deliberate (mechanical) local weakening is preferably located in a peripheral region in the direct vicinity of the edge, for example in the region of a peripheral seal (if such a seal is present) and in any case not projecting or projecting not more than a few cm inward from the peripheral seal or the frame. In particular, the clearance of the deliberate local weakening or its dimension measured perpendicular to the edge can, in illustrative embodiments, be not more than 10% of the corresponding width or height of the glazing.

For practical reasons, it can be advantageous for the deliberate local weakening to be in the form of a removal of material on the outer side of the glass pane facing away from the intermediate layer. However, this is not a necessary condition. In many embodiments, it is also possible to provide the local weakening on the inner side on both sides or from the edge.

In the case of a fire protection glazing component with a frame, the deliberate local weakening thus preferably does not extend into the clear region or extends at most into a peripheral region of the clear region.

Toughened glasses have zones having different stresses, in particular a compressive stress zone and a tensile stress zone. In the case of thermally toughened glasses, the compressive stress zone is on the outside and the tensile stress zone is on the inside. When the glass pane is toughened by the deliberate local weakening, the extension of local weakening is preferably entirely in a single stress zone and, thus, does not break through any zone boundary between the compressive stress zone and the tensile stress zone. In the case of toughened glasses whose compressive stress zone is on the outside (which includes thermally toughened glasses), the weakening is present entirely within the compressive stress zone.

### BRIEF DESCRIPTION OF THE DRAWINGS

Examples of the invention are explained below in more detail with the aid of figures. In the figures, identical reference numerals denote identical or analogous elements. In the figures:

FIGS. 1a to 1f schematically show various constructions of fire protection glazing;

FIGS. 2 to 6 show configurations of local mechanical weakenings of a glass pane in the peripheral region;

FIG. 7 shows a cross-section of a toughened glass having a compressive stress zone and a tensile stress zone;

FIG. 8 shows a view of a glass pane with possible arrangements of the local weakening;

FIGS. 9 to 12 show views of glass panes having local weakenings;

FIG. 13 shows a fire protection glazing component with a frame and packing; and

FIGS. 14a to 14d show depictions of a glass pane according to an example.

### DETAILED DESCRIPTION OF THE INVENTION

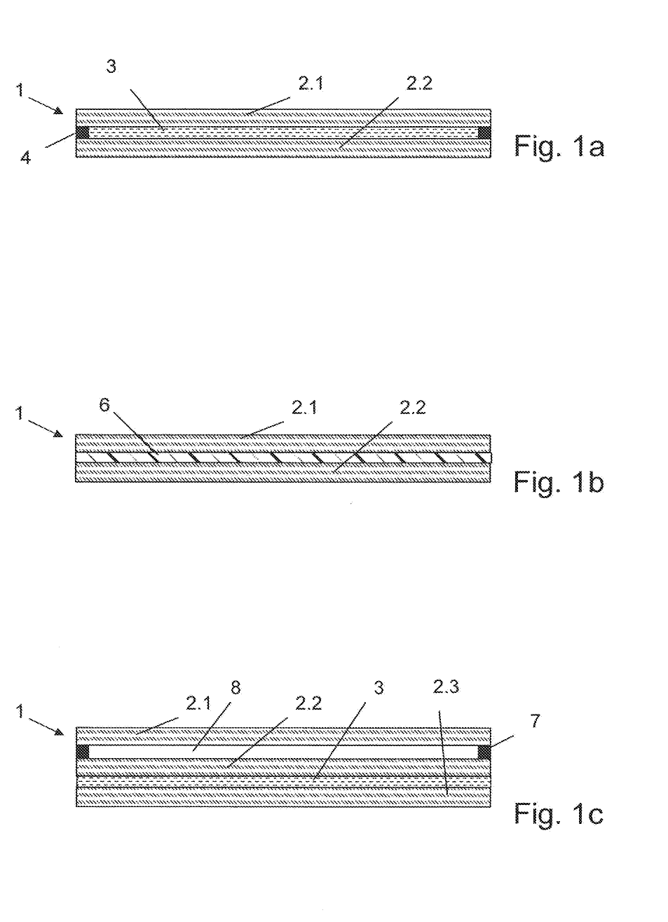

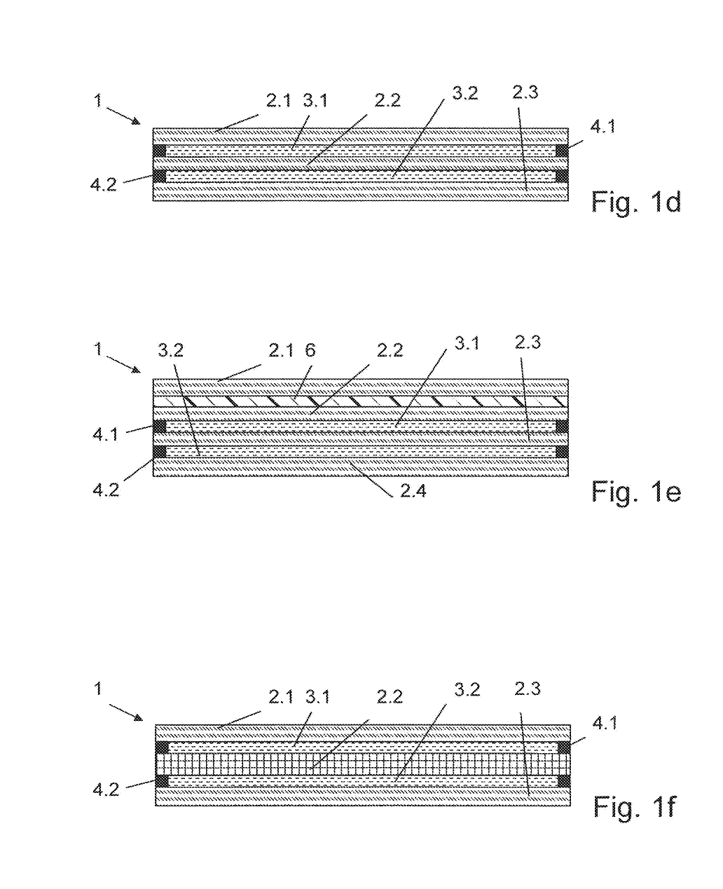

Various kinds of fire protection glazing comprising an intermediate layer and which can be provided with at least one deliberate local weakening (not shown in FIGS. 1a-1f) according to the invention's approach are initially described briefly based on the schematic FIGS. 1a-1f showing:

FIG. 1a fire protection glazing 1 having two glass panes 2.1, 2.2 with an intumescent fire protection layer 3 arranged between them and with a peripheral seal 4; the glass can, for example, be produced by curing of the fire protection composition, which is initially introduced in liquid form into the intermediate space defined with the aid of the peripheral seal 4 (rim bond) between the glass panes 2.1, 2.2 and thermally cured there.

FIG. 1b fire protection glazing 1 composed of two toughened glass panes 2.1, 2.2 which are joined to one another by a polymer layer 6, for example PVB, or a silicone layer.

FIG. 1c fire protection glazing 1 having two glass panes 2.2, 2.3 and an intumescent intermediate layer 3 arranged between them, but without a peripheral seal. The intermediate layer is, for example, produced by drying of a fire protection composition on one of the glass panes 2.2, 2.3. In addition, the fire protection glass comprises a further glass pane 2.1, with an insulating, gas-filled or evacuated intermediate space 8, which is sealed from the outside by means of a gas-tight peripheral seal 7, being present between the fire protection glazing composed of the two glass panes 2.2, 2.3 and the intumescent intermediate layer, on the one side, and the additional glass pane 2.1, on the other side. FIG. 1c is, thus, an example of an insulating fire protection glass; of course, insulating fire protection glass can also be present in different configurations, for example with an intumescent intermediate layer 3 having a peripheral seal 4, in configurations having a plurality of intumescent and/or non-intumescent intermediate layers, etc.

FIG. 1d fire protection glazing 1 comprising three glass panes 2.1, 2.2, 2.3 with intumescent fire protection layers 3.1, 3.2 arranged between them, here in each case with a peripheral seal 4.1, 4.2; fire protection glazing comprising more than three glass panes and more than two intumescent intermediate layers and/or gas-filled or evacuated intermediate spaces are also possible.

FIG. 1e fire protection glazing 1 having three glass panes 2.2, 2.3, 2.4 with intumescent fire protection layers 3.1, 3.2 arranged between them; here likewise in each case with a peripheral seal 4.1, 4.2, and with a further glass pane 2.1 which is fastened by means of a further intermediate layer 6 composed of polymer to the fire protection glass composed of the three glass panes 2.2, 2.3, 2.4 and the intumescent intermediate layers 3.1, 3.2.

FIG. 1f fire protection glazing 1 having a structure similar to the fire protection glazing as per FIG. 1d (likewise with or without peripheral seal), but in this case the middle one 2.2 of the three transparent support elements is not present as (thermally toughened) glass pane, but as glass-ceramic pane. In this embodiment, the two outermost support elements 2.1, 2.3 present as thermally toughened glass panes (SPSG), for example, can each be provided with a deliberate local weakening; such a weakening of the glass-ceramic pane 2.2 is also not ruled out.

In each of these configurations, at least one glass pane adjoining an intermediate layer 3, 3.1, 3.2, 6 is provided with a deliberate local weakening, which serves as a predetermined breaking point. In the embodiments having an intumescent intermediate layer, particular preference is given to all glass panes adjoining an intumescent fire protection intermediate layer 3, 3.1, 3.2 being provided with a weakening. In the embodiments (e.g. FIG. 1b) without an intumescent intermediate layer or possibly in all embodiments (for example also the embodiment as shown in FIG. 1e), all glasses or plates positioned on an intermediate layer 6; 3, 3.1, 3.2 are preferably provided with a deliberate local weakening.

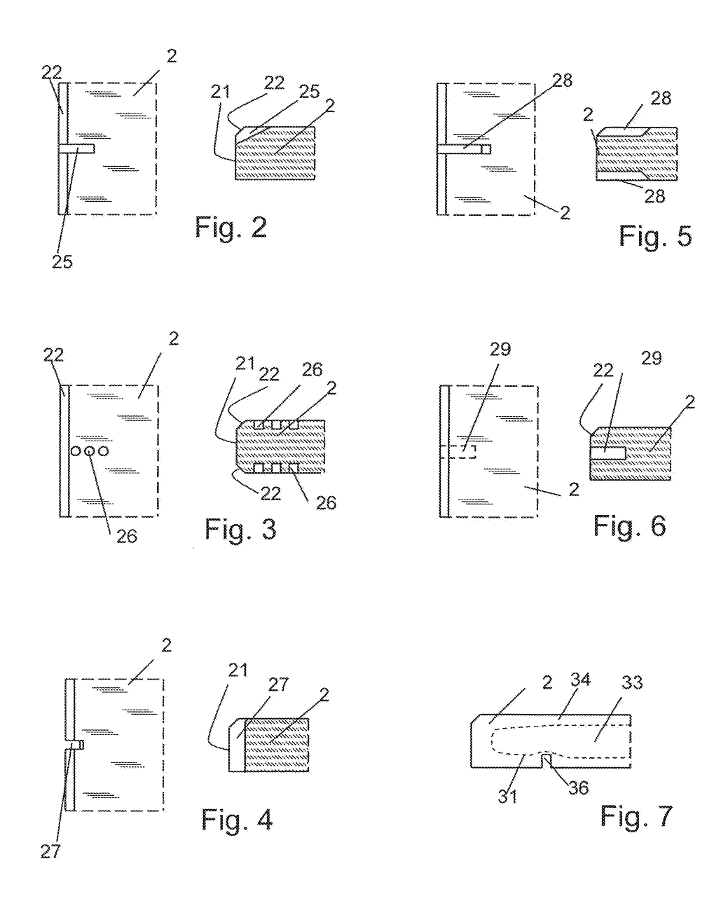

FIGS. 2 to 6 show, by way of example, possible embodiments of local weakenings of a glass pane in the peripheral region. Each of the figures shows, on the left, a view of a section of the surface of a glass pane 2 from the flat side and in the region of an edge 21. On the right, the figures each show a depiction of the glass pane cut vertically to the plane of the plate through the weakening, likewise in the edge region. In the examples shown, the glass pane is provided with a chamfer 22 at the edge, in each case on one side or both sides; however, such a chamfer is optional and all embodiments shown can, in each case, be realized on glass panes without a chamfer and on glass panes having one chamfer (on one or the other side) and also on glass panes having a chamfer on both sides. A chamfer can in these cases be a “broken” or “ordered” edge, a planed edge and/or a polished edge (see, for example, EN 12150-1, November 2000 version, item 7).

The local weakening as shown in FIG. 2 is a furrow which is present on only one side and is configured in the embodiment shown as a notch 25.

The local weakening in the embodiment shown in FIG. 3 has a plurality of blind drilled holes 26 arranged next to one another. In the example depicted, the local weakening is in the form of three pairs of blind holes aligned with one another, which pairs are arranged in a row which runs perpendicular to the edge. However, it is also possible for the blind hole or blind holes to be provided on only one side of the glass plate 2, to provide a number of blind holes different from the number shown and/or other arrangements. The shape of the blind holes (in the depicted example cylindrical) is also only one of many possibilities. In particular, it is also possible to provide, for example, annular depressions or conical depressions or other shapes; holes passing right through are also possible.

In FIG. 4, the local weakening is configured as a furrow 27 in the edge 21 of the glass pane.

FIG. 5 shows an example in which the local weakening likewise has a furrow 28 having, in contrast to the notch shown in FIG. 2, a constant depth in sections, with the furrow being introduced into the flat side and running away from the edge and approximately perpendicular thereto. In addition, the local weakening is, in the example shown, optionally present as a pair of furrows located opposite one another in the two flat sides.

It would also be possible to provide a weakening as a furrow on one flat side or on both flat sides if the furrow does not run up to the edge; in principle, a furrow can even run parallel to the edge or have a nonlinear course. Provision of a furrow either in the edge (as in FIG. 4) or up to the edge (as in FIG. 2 or FIG. 5) can, however, be advantageous for production engineering reasons; in addition, such furrows have been found to be effective.

Finally, FIG. 6 shows a variant in which the local weakening is configured as a hole 29 running from the edge into the interior of the glass pane.

In all the embodiments of FIGS. 2 to 6, the glass pane is configured per se as a convex body in the mathematical sense and the weakening represents a deviation from the convex shape. This creates, as desired, a deliberate weak point which serves as a predetermined breaking point.

FIG. 7 schematically shows a section through a thermally toughened glass pane having a chamfer in the region of the edge. Toughened glasses have an outer compressive stress zone 34 and an inner tensile stress zone 33. The zone boundary 31 should not be interrupted because otherwise the glass pane is not mechanically stable. In the case of toughened glasses, the deliberate local weakening is therefore preferably arranged so that the entire weakening (furrow/notch, depression, hole, etc.) runs within the compressive stress zone. In the case of an (in any case preferred) introduction of the weakening before thermal prestressing, the run of the zone boundary may be influenced by the weakening itself. In particular, it can be locally moved inwards in the region of the weakening. The local weakening can thus also meet the condition that the mechanical local weakening runs within the compressive stress zone when it extends further into the interior of the glass pane than the zone boundary of the unweakened glass. This is illustrated schematically in FIG. 7 by means of a notch 36 introduced before thermal prestressing: the zone boundary 31 deviates inward to a certain degree around the notch 36. In the particular case, an attempt can be made to verify whether the condition is or is not satisfied by means of modeling calculations and/or by making the zone boundary optically visible.

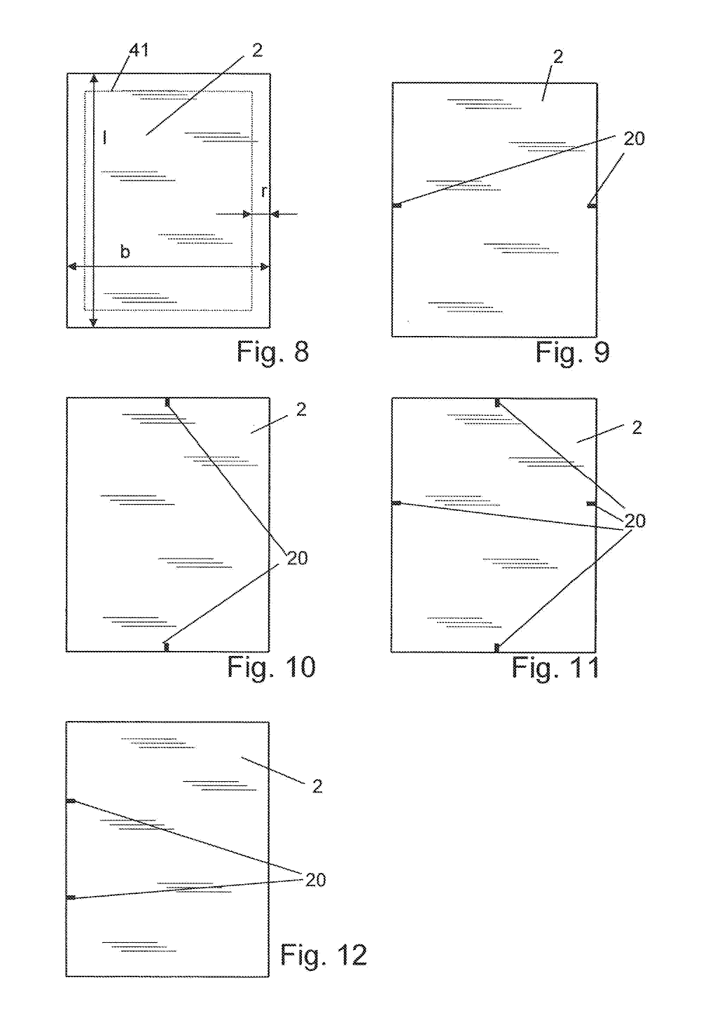

In FIGS. 8 to 13, the arrangement of the (mechanical) deliberate local weakening on a glass pane for fire protection glazing is illustrated further. Each of these figures schematically shows a view onto one of the flat sides of a glass pane 2.

FIG. 8 shows a dotted line 41 which divides a marginal region from a central region. The deliberate local weakening preferably extends entirely within the peripheral region. The width r of the peripheral region can be dependent on the frame construction selected: in the installed state of the fire protection glazing, the local weakening is advantageously covered completely by the frame. As an alternative, the local weakening can also extend a little into the clear region, but the “main zone” remains free of impairment by the local weakening. In general and independently of the choice of frame, the width r of the peripheral zone can, for example, be not more than 10% of the width b of the glass pane or not more than 10% of the length/of the glass pane.

In the embodiment shown in FIG. 9, two local weakenings 20 are present on edges having the longest longitudinal dimension (i.e. along the long sides; on the long edges). Introduction of at least one weakening, or as shown in FIG. 9 one local weakening on each of the two long edges, is a preferred arrangement in many situations.

FIG. 10 shows an alternative arrangement of two local weakenings opposite one another along the narrow sides, likewise in each case approximately in the middle. In the embodiment shown in FIG. 11, the local weakenings 20 are present both along the long sides and also along the narrow sides, in each case in the middle. Finally, the embodiment shown in FIG. 12 has two local weakenings along a long side; analogously, two local weakenings can also be present on each of the two long edges. Many further arrangements are conceivable, and the arrangements may be adapted to specific circumstances such as frame constructions or architectonic boundary conditions.

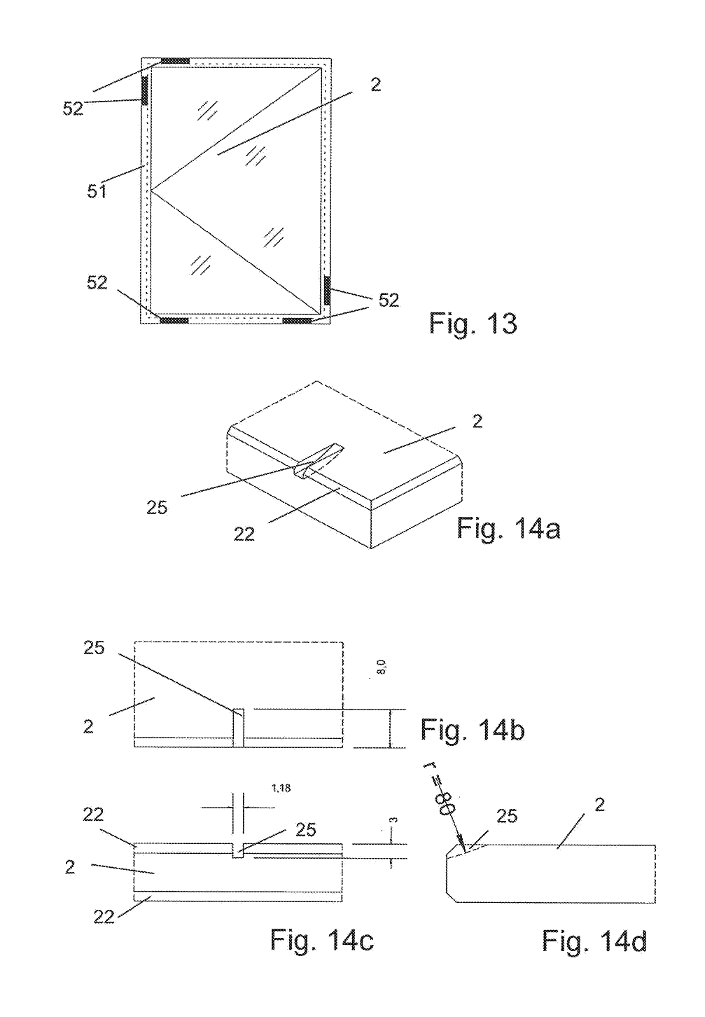

FIG. 13 shows a schematic depiction of a fire protection glazing component having a frame 51. The outline of the glass panes with a fire protection intermediate layer in between is shown by the broken line. The local weakening(s) is/are completely covered by the frame 51. The reference numeral 52 schematically denotes a possible arrangement of the packing.

In the examples illustrated, a rectangular shape of the fire protection glass was assumed in each case. Of course, the illustrated shape is merely one of many possibilities; in particular, shapes having a greater ratio of length to width or having a smaller ratio of length to width through to square shapes are also conceivable. Furthermore, the invention is also suitable for examples having shapes other than rectangular. The shape of the fire protection glass pane is all in all not a critical parameter; however, the procedure according to the invention has proved particularly useful in the case of shapes having a large ratio between a length and a width (insofar as these two parameters are clearly defined).

FIGS. 14a to 14d illustrate a further example of a glass pane 2. The notch 25 is cut by means of a parting disk having a radius of 80 mm and a disk thickness of 1.18 mm before thermal prestressing; the depth of the notch as its deepest point (at the edge) is 3 mm, and the extension into the plane of the plate is 8 mm.

Fire protection tests in which glazing composed of two glass panes each as per the example in FIGS. 14a to 14d having a cured, intumescent fire protection layer based on alkali metal silicate in between (SGG CONTRAFLAM® 30 panes; structure of the glasses 5 mm SPSG/6 mm silicate intermediate layer/5 mm SPSG, pane size 665×1890 mm) and outward direction of the notch 25 was subjected to high temperatures under standard test conditions in accordance with EN 1363/ISO 834 reproducibly gave fracture of the fire-side (hot-side) glass pane extending from the local weakening even at a comparatively early point in time, as a result of which a pressure buildup in the intermediate space between the glass panes could be reliably prevented. In particular, bursting was observed after half as long a time (2 minutes instead of 4 minutes) as without deliberate weakening. The cold-side glass pane and the intermediate layer remained unaffected by this fracture.

In a further example, a glass as per the above example, but with orientation of the notch in an inward direction was used. This too, led reliably to earlier fracture, wherein the fracture was observed less early than in the case of the fire protection glass as per the first example.

1. A fire protection glazing comprising:
at least two transparent support elements and
an intermediate layer arranged between the support elements,
wherein at least one of the support elements is a glass plate provided with at least one defined local weakening.

2. The fire protection glazing as claimed in claim 1, wherein the intermediate layer is a fire protection layer which intumesces or releases glass in the case of fire.

3. The fire protection glazing as claimed in claim 1, wherein under the action of heat the intermediate layer causes an increase in pressure which goes beyond the increase in pressure according to the general gas equation for ideal gases.

4. The fire protection glazing as claimed in claim 1, wherein at least two support elements joined by the intermediate layer or one of the intermediate layers are glass plates which are each provided with at least one local weakening.

5. The fire protection glazing as claimed in claim 1, wherein the glass plate provided with at least one local weakening or at least one of the glass plates provided with the at least one local weakening is a toughened glass.

6. The fire protection glazing as claimed in claim 1, wherein the local weakening is present as a positionally defined and delimited removal of material in the form of a furrow, notch, an indentation or a hole carried out on the glass plate.

7. The fire protection glazing as claimed in claim 6, wherein the local weakening is present as a furrow.

8. The fire protection glazing as claimed in claim 7, wherein the furrow extends inwards from an edge of the glass plate on a flat side.

9. The fire protection glazing as claimed in claim 7, wherein the furrow is present at an edge of the glass plate.

10. The fire protection glazing as claimed in claim 5, wherein the local weakening is arranged within a stress zone and does not cross any boundary between two stress zones.

11. The fire protection glazing as claimed in claim 1, wherein the glass plate is a mathematically convex body and the local weakening represents a deviation from the convex nature.

12. The fire protection glazing as claimed in claim 1, wherein the glazing comprises at least three transparent support elements, with a gas-filled or evacuated intermediate space being present between two of the support elements, as a result of which the glazing becomes an insulating fire protection glass.

13. The fire protection glazing as claimed in claim 1, wherein the at least one glass plate is flat, arched or curved.

14. The fire protection glazing as claimed in claim 7, wherein the furrow is a notch.
